(19) United States
(12) Patent Application Publication
(10) Pub. No.: US 2026/0266245 A1
(43) Pub. Date: Sep. 10, 2026

(54) DUCTED FUEL INJECTION STRATEGY EMPLOYING AIR JET INJECTION FOR AIDING SOOT OXIDATION

(71) Applicant: Caterpillar Inc., Peoria, IL (US)

(72) Inventor: Russell P. Fitzgerald, Peoria, IL (US)

(73) Assignee: Caterpillar Inc., Peoria, IL (US)

(21) Appl. No.: 19/069,668

(22) Filed: Mar. 4, 2025

(51) Int. Cl. F02M 23/00; F02M 61/18

(52) U.S. Cl. CPC F02M 23/00; F02M 61/18

(57) ABSTRACT

A combustion system in an internal combustion engine system includes a cylinder head, a fuel injector supported in the cylinder head, and a plurality of spray ducts each arranged to duct a fuel spray jet from a spray orifice of the fuel injector. The combustion system also includes a plurality of air injectors arranged to inject air jets targeting at least one of the plurality of spray ducts or combusting spray plumes therefrom. The air jets can aid oxidation of particulate matter by way of preventing impingement of combusting spray plumes on the spray ducts. Related methodology is also disclosed.

### TECHNICAL FIELD

The present disclosure relates generally to ducted fuel injection, and more particularly to injecting air jets in a ducted fuel injection engine to limit interaction between a combusting fuel spray plume and a spray duct.

### BACKGROUND

Modern internal combustion engines include one or more cylinders each having an associated piston together forming a combustion chamber or cylinder. Fuel for combustion is admitted into the combustion chamber commonly by way of a fuel injector. Fuel injectors can be arranged as direct injectors directly injecting the fuel and extending into the combustion chamber, or as port-injectors or manifold-injectors, for example. Fuel injectors typically include several spray orifices, the opening and closing of which is controlled by way of a needle valve or similar component sometimes referred to as a check.

Depending upon fuel type, combustion of the fuel in the cylinder tends to produce a range of emissions in exhaust from the engine, some of which are considered undesirable. Many strategies are known for filtering, chemically reducing, or otherwise treating exhaust constituents to limit discharge in the exhaust. In recent years, there has been great interest in controlling and/or managing the manner and mechanisms of combustion in-cylinder in an effort to control the exhaust emissions profile of internal combustion engines so as to reduce or eliminate requirements for aftertreatment strategies.

Ducted fuel injection assemblies have been implemented in some engines to enhance mixing and reduce an amount of particulate matter, namely, soot, formed in a combustion chamber. Ducted assemblies typically include one or more tubular structures supported adjacent to the fuel injector by way of attachment to the cylinder head or to the fuel injector itself and positioned such that the ducts receive fuel spray jets from the fuel injector. The fuel spray tends to interact with the ducts to ultimately enhance mixing of the fuel with air, in particular by increasing the so-called “liftoff” length of the fuel spray jets to increase mixing of air with the plumes of fuel. One known ducted fuel injection application is set forth in United States Patent No. 11,885,290 B2 to John et al. While known ducted injection strategies present great promise for reduced emissions operation, there is always room for development of improvements and alternatives.

### SUMMARY

In one aspect, a combustion system includes a cylinder head arranged to form, in part, a cylinder, and a fuel injector supported in the cylinder head and having a plurality of spray orifices formed therein. The combustion system further includes a plurality of spray ducts each arranged to duct a fuel spray jet from a respective one of the plurality of spray orifices, and a plurality of air injectors each arranged to inject an air jet in an impingement path targeting at least one of a respective one of the plurality of spray ducts or a combusting spray plume therefrom.

In another aspect, an engine system includes an engine having an engine housing with a cylinder formed therein, and including a cylinder head. The engine system also includes a fuel injector supported in the cylinder head, and a plurality of spray ducts arranged to duct a plurality of fuel spray jets from the fuel injector into the cylinder. The engine system further includes a plurality of air injectors each arranged to inject an air jet in an impingement path targeting at least one of a respective one of the plurality of spray ducts or a combusting spray plume therefrom.

In still another aspect, a method of operating an engine includes ducting a plurality of spray jets of a fuel from a fuel injector through a plurality of spray ducts into a cylinder, and injecting air jets into the cylinder in impingement paths targeting at least one of a respective one of the plurality of spray ducts or a spray plume therefrom. The method further includes combusting the fuel in the cylinder.

### BRIEF DESCRIPTION OF DRAWINGS

FIG. 1 is a partially sectioned side diagrammatic view of an engine system, according to one embodiment;

FIG. 2 is an elevational view of portions of a combustion system, according to one embodiment; and

FIG. 3 is a diagrammatic view of a combustion system, according to one embodiment.

### DETAILED DESCRIPTION

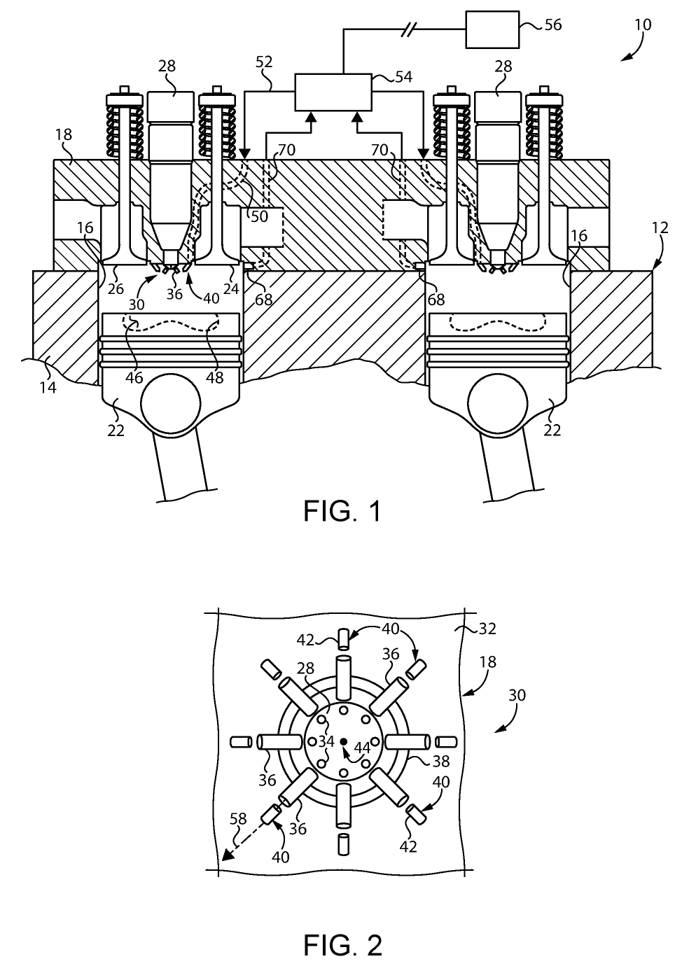

Referring to FIG. 1, there is shown an internal combustion engine system 10, according to one embodiment. Engine system 10 includes an internal combustion engine 12 having a cylinder block 17 with a plurality of cylinders 16 formed therein. A cylinder head 18 is attached to cylinder block 14. A plurality of pistons 22 are positioned in cylinders 16 and each movable in a generally conventional manner between a bottom-dead-center position and a top-dead-center position, typically in a four-stroke engine cycle. Cylinders 16 can include any number, in any suitable arrangement such as an inline pattern, a V-pattern, or still another. Each cylinder 16, hereinafter referred to, at times, in the singular, is associated with one or more intake valves 24 and one or more exhaust valves 26. Intake valve 24 and exhaust valve 26 open and close to provide admission of intake air for combustion, and expelling of exhaust, respectively.

Engine 12 may be compression-ignited, such that pistons 22 are movable to increase a pressure and temperature within the respective cylinder 16 to an autoignition threshold for a directly injected compression-ignition fuel. Suitable fuels can include a diesel fuel, such as a diesel distillate fuel, or lower cetane fuels blended with a cetane enhancer, for example. Engine 12 further includes a plurality of fuel injectors 28 each arranged as direct injectors extending partially into a respective cylinder 16. Fuel injectors 28 may be electronically controlled and hydraulically actuated. Engine system 10 can be applied for any known purpose including operating a driveline in a land vehicle or a marine vessel, or powering a pump, a compressor, or an electrical generator, to name a few examples.

Referring also now to FIG. 2, components of engine system 10 may be arranged to form a combustion system 30. Combustion system 30 includes cylinder head 18 arranged to form, in part, cylinder 16, and having a fire deck 32 exposed to the respective cylinder 16. Combustion system 30 also includes fuel injector 28 supported in cylinder head 18 and having a plurality of spray orifices 34 formed therein. Spray orifices 34 can be opened and closed in a generally conventional manner to inject fuel spray jets of pressurized fuel from each respective one thereof. A number of spray orifices 34 may be at least two, and commonly, three, four, five, or more. Those skilled in the art will be familiar with internal fuel injector components and operation to selectively inject a fuel for combustion at a desired injection timing.

Combustion system 30 also includes a plurality of spray ducts 36 each arranged to duct a fuel spray jet from a respective one of spray orifices 34. Spray ducts 34 may be attached to a holder 38 that is in turn attached to fire deck 32 or potentially to fuel injector 28 itself, or to both. In some embodiments, each of the plurality of spray ducts 36 may be attached together with holder 38 to form a separate component that can be installed for service in cylinder head 18. Fuel injector 28 defines a center axis 44. In the illustrated embodiment each of spray ducts 36 defines an outgoing spray plume path extending radially outward and axially downward relative to center axis 24. Combustion system 30 also includes a plurality of air injectors 40 each arranged to inject a pressurized air jet in an impingement path targeting at least one of a respective one of spray ducts 36 or a combusting spray plume therefrom. Fuel in spray jets ducted through spray ducts will typically compression-ignite shortly after exiting the respective spray duct 36.

Returning focus to FIG. 1, combustion system 30 may further include piston 22. Piston 22 forms, together with cylinder head 18, cylinder 16. Piston 22 may also form a combustion bowl 46 having a bowl outer wall 48. In an implementation, combustion bowl 46 may be reentrant. Spray ducts 36 may define a plurality of spray plume paths targeting a surface of combustion bowl 46.

As noted above, air injectors 40 are each arranged to inject an air jet. Air injectors 40 may each include a nozzle 42 extending into cylinder 16 and can receive a supply of pressurized air from a variety of sources. Embodiments are contemplated where an on-board air compressor provides a feed of pressurized air to air injectors 40. In one practical implementation, air injectors 40 receive a feed of pressurized air from another cylinder in engine 12.

Air injectors 40 may each include a plurality of air admission conduits 50 formed in cylinder head 18. Air admission conduits 50 for each respective cylinder 16 may connect to a common air supply line 52. Also in a practical implementation, combustion system 30 may further include an air valve assembly 54 arranged to be positioned fluidly between another cylinder 16 and common air supply line 52. For instance, referring to the leftmost cylinder 16 as a first cylinder in FIG. 1 and the rightmost cylinder 16 as a second cylinder, air valve assembly 54 is arranged fluidly between the second cylinder 16 and common air supply line 52. Each cylinder 16 may further include or be coupled to an air inlet 68 of cylinder block 14 or cylinder head 18 that can receive pressurized air from the respective cylinder and feed the same through an air line 70 to air valve assembly 54. Air valve assembly 54 is thus adjustable to provide an appropriate fluid connection, at an appropriate timing, to feed pressurized air from the second cylinder 16 to the first cylinder 16 for injecting the respective air jets by way of air injectors 40.

It will further be appreciated that pistons 22 and respective cylinders 16 will be out of phase with one another during operation. Accordingly, when the first cylinder 16 is injecting fuel, just prior to ignition, the second cylinder 16 will be out of phase and potentially available to supply the feed of pressurized air. After the first cylinder 16 has completed an intake stroke in an engine cycle, and before completing a compression stroke, it can be possible to siphon off pressurized air. Air valve assembly 54 may be electronically controlled to provide the appropriate fluid connections at the appropriate timings and is in communication with an electronic control unit 56 for such purposes.

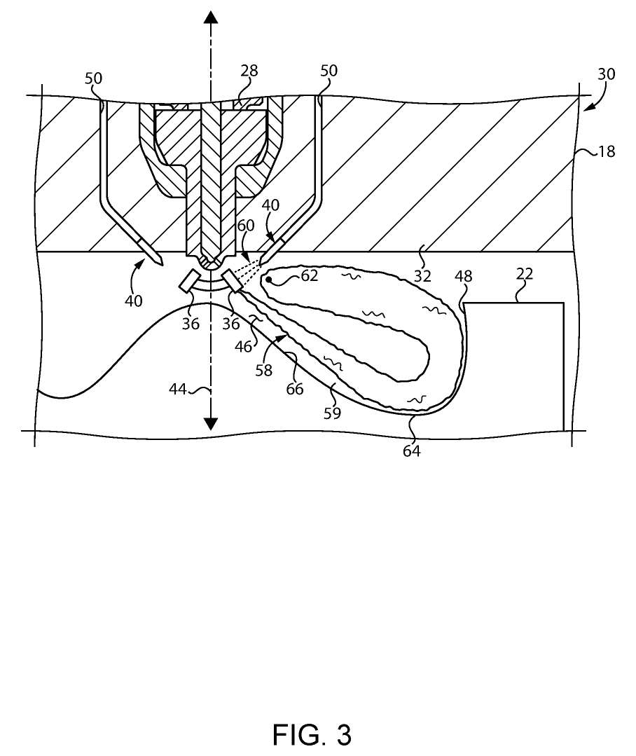

Referring also now to FIG. 3, there are shown features of combustion system 30 in engine system 10 in further detail and illustrating events during an example injection of fuel and injection of air. In the FIG. 3 illustration one spray duct 36 is shown as it might appear having ducted a spray jet of fuel to produce an outgoing combusting spray plume 59 generally in an outgoing spray plume path 58. Plume path 58 extends radially outward and axially downward relative to central axis 44 of fuel injector 28 as discussed above. It can also be noted from FIG. 3 that piston 22 includes combustion bowl 36 formed at least in part by a cone slope surface 66 of a center cone, a bowl floor 64, and bowl outer wall 48. It will be recalled combustion bowl 46 may be reentrant. Accordingly, spray plume 59 advances outwardly of spray duct 36 and impinges upon approximately bowl floor 64, then travels axially upward along bowl outer wall 48 and is redirected generally radially inward, and potentially deflecting off of fire deck 32. A leading portion 62 of fuel plume 59 eventually approaches spray duct 36.

It has been discovered that impingement of a combusting spray plume upon a spray duct can result in sub-optimal oxidation of constituents of the fuel plume, resulting in exhaust emissions of soot. Without being bound by theory, it is believed that impingement of a combusting fuel plume upon the spray duct may cause quenching or cooling, reduced access to available oxygen for combustion, or otherwise disturb the combustion process in such a way that soot formation is promoted. According to the present disclosure, the air jets advancing outwardly from air injectors 40 may have impingement paths 60 that extend radially inward and axially downward relative to center axis 44 and limit impingement of the spray plume upon spray duct 36. As noted above, each of the air jets may target at least one of a respective one of spray ducts 36 or a combusting spray plume therefrom. In the illustration of FIG. 3 it can be seen that impingement path 60 directly impinges upon spray duct 36, potentially displacing fuel of spray plume 59 so as to prevent or reduce contact between the fuel and spray duct 36 and providing additional air for oxidation.

### INDUSTRIAL APPLICABILITY

Referring to the drawings generally, operating engine 12 can include ducting a plurality of spray jets of fuel from fuel injector 28 through spray ducts 36 into cylinder 16. Operating engine 12 can also include injecting air jets into cylinder 16 in impingement paths targeting spray ducts 36 or fuel plumes from spray ducts 36, or both. As explained above, air injection according to the present disclosure is believed to aid oxidation of particulate matter. Promoting the burning of fuel and/or soot that would otherwise be emitted in the exhaust may also contribute to improved efficiency, and reducing or eliminating the need for aftertreatment particulate traps and the like. It is contemplated that certain applications of the present disclosure may substantially completely eliminate opportunities for in-cylinder soot formation.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A combustion system comprising:
a cylinder head arranged to form, in part, a cylinder;
a fuel injector supported in the cylinder head and having a plurality of spray orifices formed therein;
a plurality of spray ducts each arranged to duct a fuel spray jet from a respective one of the plurality of spray orifices; and
a plurality of air injectors each arranged to inject an air jet in an impingement path targeting at least one of a respective one of the plurality of spray ducts or a combusting spray plume therefrom.

2. The combustion system of claim 1 further comprising a piston forming a combustion bowl, and the plurality of spray ducts defining a plurality of spray plume paths targeting a surface of the combustion bowl.

3. The combustion system of claim 2 wherein the combustion bowl is reentrant.

4. The combustion system of claim 1 wherein the plurality of air injectors include a plurality of air admission conduits formed in the cylinder head and connecting to a common air supply line.

5. The combustion system of claim 4 wherein the cylinder head is arranged to form, in part, a second cylinder, and further comprising an air valve assembly arranged to be positioned fluidly between the second cylinder and the common air supply line.

6. The combustion system of claim 1 wherein each respective impingement path targets the respective one of the plurality of spray ducts.

7. The combustion system of claim 1 wherein each of the plurality of spray ducts defines a spray plume path extending radially outward and axially downward relative to a center axis of the fuel injector, and each of the plurality of impingement paths extends radially inward and axially downward relative to the center axis.

8. The combustion system of claim 7 wherein each of the plurality of air injectors includes a nozzle extending into the cylinder.

9. An engine system comprising:
an engine including an engine housing having a cylinder formed therein, and including a cylinder head;
a fuel injector supported in the cylinder head;
a plurality of spray ducts arranged to duct a plurality of fuel spray jets from the fuel injector into the cylinder; and
a plurality of air injectors each arranged to inject an air jet in an impingement path targeting at least one of a respective one of the plurality of spray ducts or a combusting spray plume therefrom.

10. The engine system of claim 9 wherein the engine housing includes a second cylinder formed therein, and further comprising a common air supply line extending between the second cylinder and the plurality of air injectors.

11. The engine system of claim 10 further comprising an air valve assembly positioned fluidly between the second cylinder and the common air supply line.

12. The engine system of claim 9 wherein each of the plurality of air injectors includes a nozzle, and each respective impingement path extends outwardly from the corresponding nozzle and targets the respective one of the plurality of spray ducts.

13. The engine system of claim 12 wherein each of the plurality of spray ducts defines a spray plume path extending radially outward and axially downward relative to a center axis of the fuel injector, and each of the plurality of impingement paths extends radially inward and axially downward relative to the center axis.

14. The engine system of claim 10 further comprising a piston within the cylinder and including therein a combustion bowl, and the plurality of spray ducts define a plurality of spray plume paths targeting a surface of the combustion bowl.

15. The engine system of claim 14 wherein the combustion bowl is reentrant.

16. The engine system of claim 9 wherein each of the plurality of spray ducts defines a spray plume path extending radially outward and axially downward relative to a center axis of the fuel injector, and each of the plurality of impingement paths extends radially inward and axially downward relative to the center axis.

17. A method of operating an engine comprising:
ducting a plurality of spray jets of a fuel from a fuel injector through a plurality of spray ducts into a cylinder;
injecting air jets into the cylinder in impingement paths targeting at least one of a respective one of the plurality of spray ducts or a spray plume therefrom; and
combusting the fuel in the cylinder.

18. The method of claim 17 further comprising guiding combusting spray plumes of the fuel in reentrant paths in the cylinder.

19. The method of claim 18 further comprising aiding oxidation of particulate matter in the combusting spray plumes of the fuel by way of the injecting air jets.

20. The method of claim 17 further comprising supplying pressurized for the injecting air jets through a cylinder head of the engine from an out-of-phase second cylinder.
